(19) United States
(12) Patent Application Publication
(10) Pub. No.: US 2001/0036131 A1
(43) Pub. Date: Nov. 1, 2001

(54) Wristwatch case

(76) Inventors: Dai Terasawa, Chiba-shi (JP); Shoichi Watase, Chiba-shi (JP)

Correspondence Address: Adams & Wilks, 31st Floor, 50 Broadway, New York, NY, 10004, US

(21) Appl. No.: 09/819,512

(22) Filed: Mar. 28, 2001

(30) Foreign Application Priority Data
Mar. 30, 2000 (JP) 2000-093517

(51) Int. Cl. A44C 5/00; G04B 37/00; G04B 29/00

(52) U.S. Cl. 368/281; 368/300

(57) ABSTRACT

A wristwatch case is structured by an outer case and an inner case mounting a movement. The inner case is structured movable vertical to a plane to provide, in a vertical movable range, a stop point where the inner case is allowed to rotate and a stop position inhibiting rotation. In a state the inner case is rotatable, the inner case can be rotated to an angle easy to see.

### BACKGROUND OF THE INVENTION

1. Field of the Invention

The present invention relates to a wristwatch case.

2. Description of the prior Art

The conventional wristwatch case could be divided into an outer case and an inner case, but the inner case could not be moved in a vertical direction. Also, it was impossible to rotate only the inner case.

In the related-art wristwatch, when the wristwatch is worn on the wrist to see it, the wristwatch is positioned in a direction easy to see by moving the wrist. However, in a state that wrist movement is put under restriction, the timepiece is in an angle not easy to see it. Also, if, in such a state, the wrist is unnaturally moved to see the timepiece, there is a possibility of inducing mistake of operation or drive.

### SUMMARY OF THE INVENTION

In the present invention, it is a problem to provide a wristwatch case which solves the foregoing problem and can change the inner case to a one's desired angle regardless of a wrist position and positively lock the rotation of the inner case in that position.

The inner case mounting a timepiece movement is structurally given a function movable generally vertical with respect to a plane of a wristwatch case, being divided into a plurality of stop points in a vertical operating range, i.e., a stop point that rotation of the inner case is positively fixed and a stop point for rotating the inner case. This makes it possible to change the inner case to a desired angle and positively lock the rotation of the inner case in that position.

According to the present invention, at the stop point for positively fixing the rotation of the inner case, the gear-formed convex-concave formed in the outer case engages a rotation-regulating portion of a concave-convex-formed gear of a rotation-regulating ring and positively regulates the rotation. At the stop point for rotation, the engagement is released from the rotation-regulating portion of the rotation-regulating ring to enable the inner case to rotate.

### BRIEF DESICRIPTION OF THE DRAWINGS

A preferred form of the present invention is illustrated in the accompanying drawings in which:

FIG. 1 is a main structure fragmentary sectional view in an inner case lower stop point of the invention;

FIG. 2 is a main structure fragmentary sectional view in an inner case upper stop point of the invention;

FIG. 3 is a main structure fragmentary sectional view in an inner case lower stop point of the invention;

FIG. 4 is an A-A arrow direction sectional view in the inner case lower position of the invention;

FIG. 5 is a main structure fragmentary sectional view in an inner case upper stop point of the invention;

FIG. 6 is a B-B arrow direction sectional view in the inner case upper position of the invention;

FIG. 7 is a plan view of a ring elastic part of the invention; and

FIG. 8 is a plan view as viewed in a glass direction of the invention.

### DETAILED DESCRIPTION OF THE PREFERRED EMBODIMENTS

An embodiment of the present invention will be explained with reference to the attached drawings.

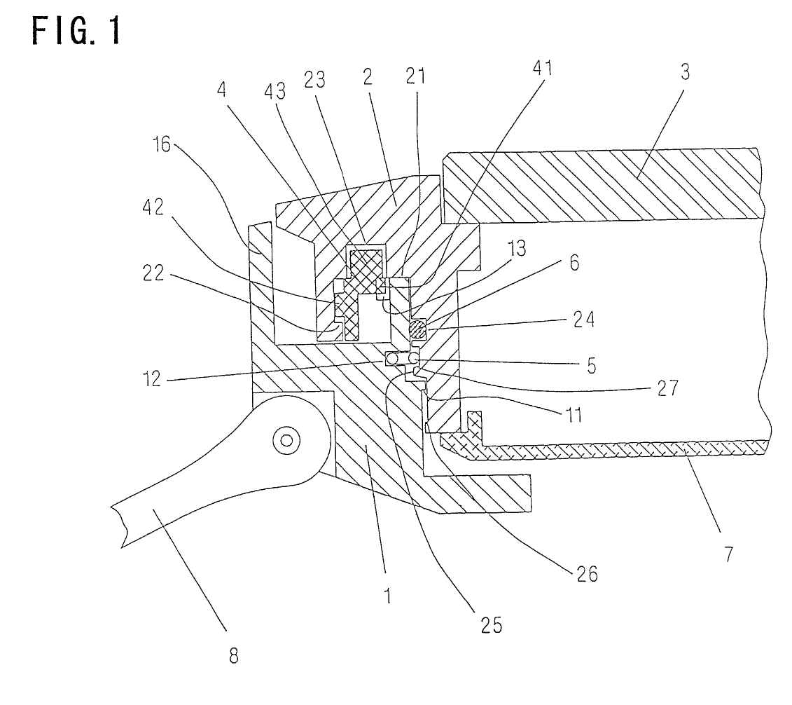

The present invention is structured, as shown in FIG. 1, by a degree-contact step 11, a positioning groove 12 holding a positioning elastic member 5, an outer case 1 having a gear-formed convex/concave portion 13, an outer case degree-contact surface 26, an inner case 2 having a positioning protrusion 25, a rotation stop dowel 43 engaged in a rotation stop hole 23, and a rotation regulating ring 4 having a rotation regulating portion 41 corresponding to the gear-formed concave-convex portion 13 and fixed in the inner case 2. Also, the inner case 2 is mounted with a timepiece movement 9.

FIG. 1 shows a state that an inner case receiving surface 14 is in contact with an outer case-receiving surface 21 of the inner case 2, which state is rendered as a lower stop point. Due to a positioning elastic member 5 held by a positioning groove 12 of the outer case 1 and a positioning protrusion 25 of the inner case 2, the inner case 2 can stop at the lower stop point.

By engaging the rotation stop dowel 43 possessed by the rotation-regulating ring 4 in a singular or plurality of rotation stop holes 23 opened in the inner case 2, the rotation-regulating ring 4 will not rotate. At this time, engagement is made between the gear-formed concave-convex portion 13 of the outer case 1 and the rotation-regulating portion 41 of the rotation-regulating ring 4 fixed by the inner case 2, so that the inner case 2 secures stop stability and will not rotate.

The rotation regulating portion 41 of the rotation regulating ring 4 fixed in the inner case 2 is provided singular or in plurality.

The stop stability is further secured for the inner case by the contact between the flatter-preventing elastic member 6 fitted in a fixing groove 24 of the inner case 2 and an elastic contact surface 15 of the outer case 1. A band 8 is provided with the outer case 1 so it is able to attach a watch on the arm. A glass 3 and a back lid 7 are fixed on the outer case 1. The outer case 1 protects the timepiece movement 9 and keeps hermeticity.

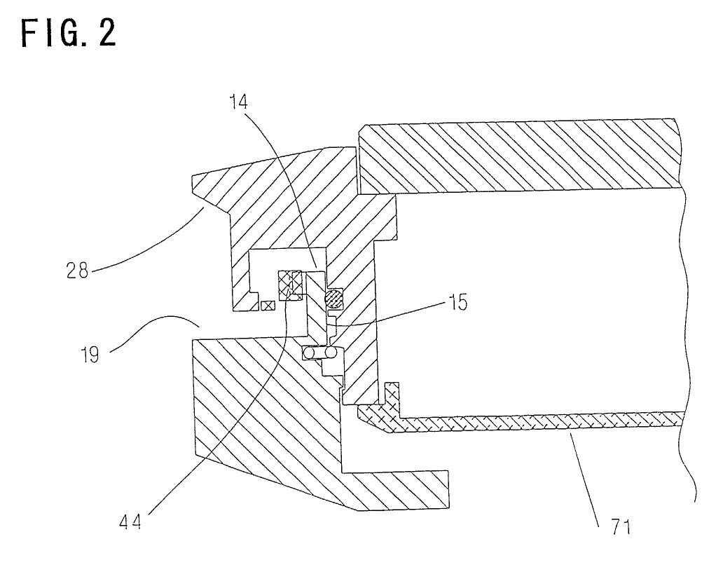

FIG. 2 shows a state that the inner case 2 is vertically moved from a finger-engaging portion 19 having no outer peripheral wall 16 to a finger-engaging slant surface 28 of the outer case 1, whereby the positioning elastic member 5 held by the positioning groove 12 of the outer case 1 deforms and gets over a positioning protrusion 25 of the inner case 2. Also, the inner case 2 may be vertically moved by finger-pressing a back-lid bottom surface 71 of the back lid 7.

At this time, the positioning elastic member 5 held by the positioning groove 12 of the outer case 1 interferes with a positioning protrusion upper slant surface 27 of the inner case 2 whereby the inner case 2 can stop at an upper stop point and the inner case 2 can be stably rotated in the upper stop point.

In this state, engagement is completely released between the gear-formed concave-convex portion 13 of the outer case 1 and the rotation-regulating portion 41 of the rotation-regulating ring 4 fixed on the inner case 2. The inner case 2 can rotate freely.

The rotation regulating ring 4 has a removal-preventing protrusion 42 such that, when the inner case 2 is moved to the upper stop position, the rotation regulating ring 4 fixed to the inner case 2 is not left together with the outer case 1 in the lower stop point. By the interference between the removal preventing protrusion 42 of the rotation regulating ring 4 and a circumferential groove lower wall 22, the rotation regulating ring 4 is not left in the lower stop point but can be moved together with the inner case 2 to the upper stop point.

In the upper stop point, meshing is made between the gear concave portion 17 of the gear-formed concave-convex portion 13 of the outer case 1 and a click elastic protrusion 45 is provided in a click elastic portion 44 of the rotation regulating ring 4 fixed in the inner case 2.

If the inner case 2 is rotated, the click elastic protrusion 45 provided in the click elastic portion 44 of the rotation regulating ring 4 is moved in a radial direction by a rotation force and intermittently interferes with the gear-formed concave-convex portion 13 formed in the outer case 1, thereby giving click feel to the inner case 2.

The rotation regulating portion 41 of the rotation regulating ring 4 and the click elastic protrusion 45 are planarly alternately arranged.

Also, the rotation regulating portion 41 of the rotation regulating ring 4 and the click elastic protrusion 45 are arranged in an upper surface and a lower surface with respect to a planar direction.

The click elastic portion 44 of the rotation regulating ring 4 and the click elastic protrusion 45 are singular or in plurality.

The outer case 1 has a degree-contact step 11 and the inner case 2 has an outer-case-degree-contact portion 26 such that, when the inner case 2 is moved in the upper direction, the inner case 2 is prevented from falling out of the outer case 1.

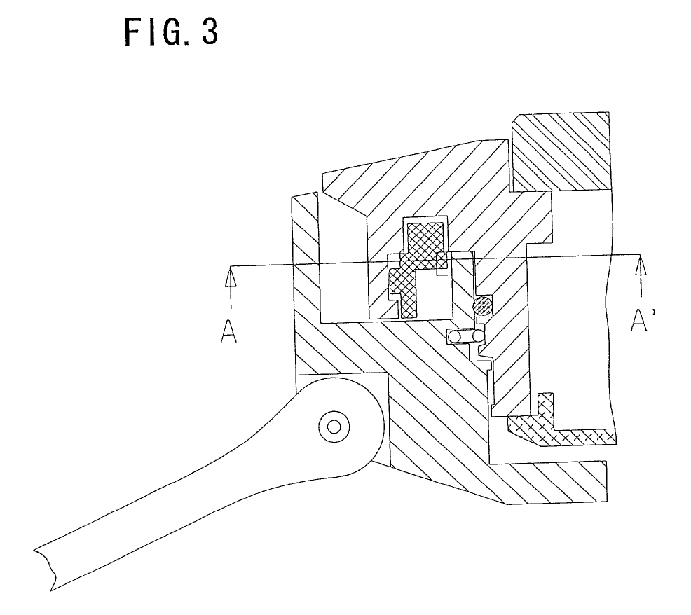

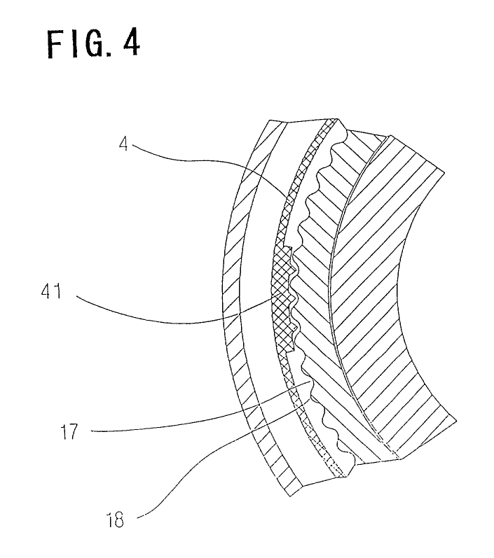

FIG. 3 shows the inner case 2 in the lower stop point, and FIG. 4 is a sectional view along line A-A in FIG. 3. The gear-formed concave-convex portion 13 having the gear concave portion 17 and the gear convex portion 18 engages the rotation-regulating portion 41 of the rotation regulating ring 4 on a plane, so the inner case 2 does not rotate.

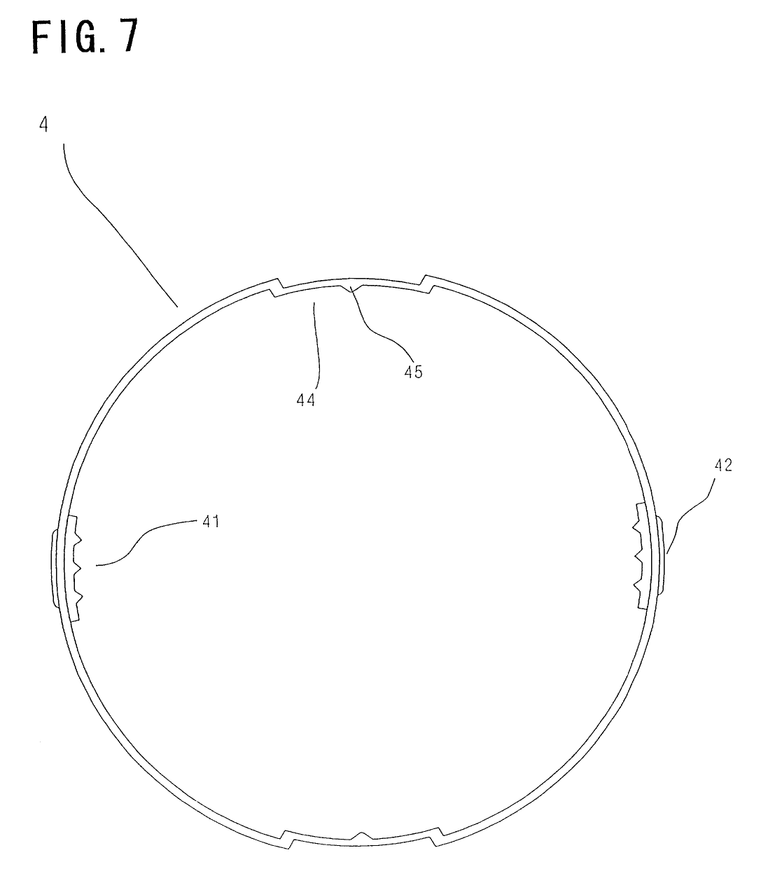

FIG. 7 shows a plan view of the rotation regulating ring 4. FIG. 7 shows a state in which the rotation-regulating portion 41 and the click elastic protrusion 45 are alternately arranged on a plane.

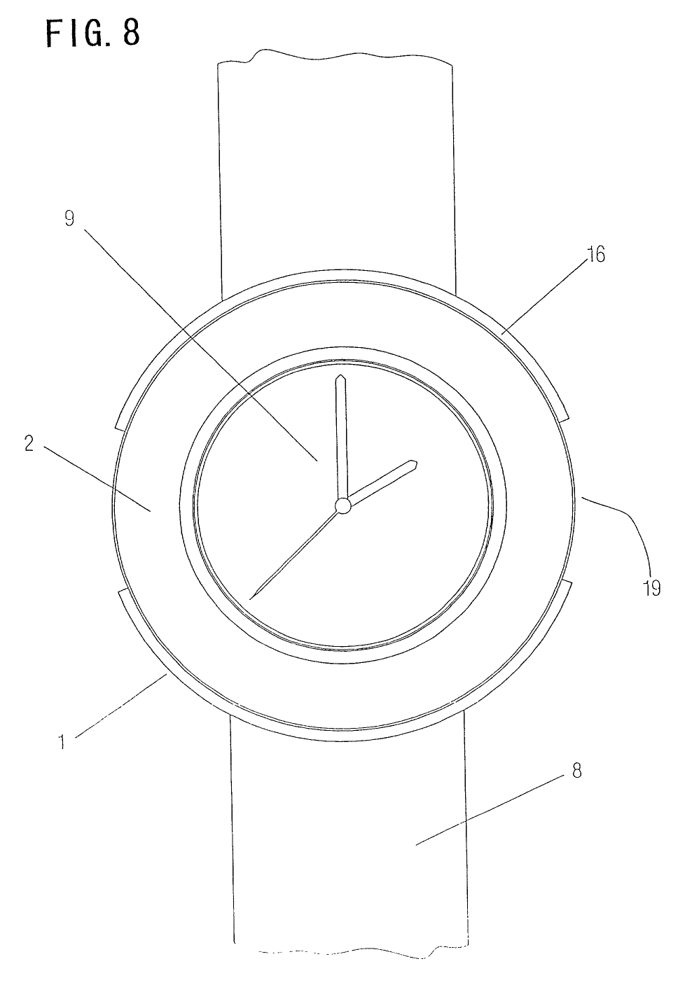

FIG. 8 shows a plan view of a watch case as viewed in a glass direction. The finger-engaging portion 19 having an outer peripheral wall 16 is provided with the outer case 1 so as to easily operate it with fingers when the inner case 2 is moved toward a vertical direction. It is better that the finger-engaging portion 19 is provided at two or more position. The band 8 is provided with the outer case 1.

In this invention, as described above, when the inner case 2 is positioned in the lower stop position, the gear-formed concave-convex portion 13 engages the rotation regulating portion 41 of the rotation regulating ring 4 to inhibit the inner case 2 from rotating. When the inner case 2 is positioned in the upper stop position, the gear-formed concave-convex portion 13 and the rotation-regulating portion 41 of the rotation-regulating ring 4 are released from engagement to enable the inner case 2 to freely rotate. Thus, a wristwatch case structure could have been realized that is different in rotation function of the inner case 2 by the stop positions.

This has made it possible to change the inner case to a desired angle easy to see the timepiece regardless of a wrist position, and lock the rotation of the inner case at that position.

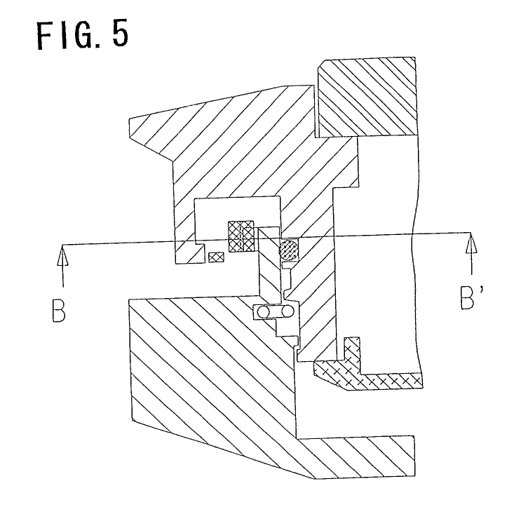

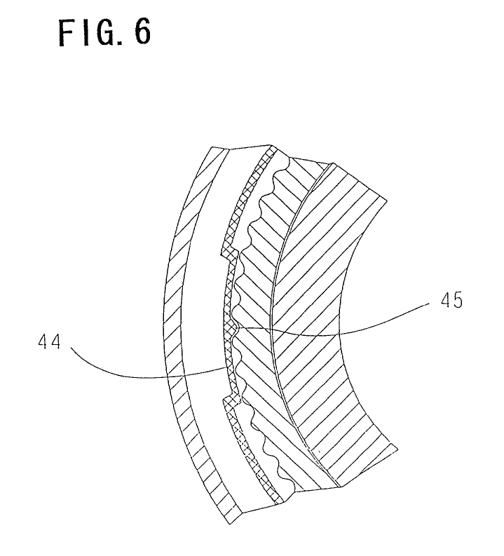

As shown in FIG. 5 and FIG. 6, in a state the inner case 2 is moved to the upper stop position, slight interference is caused between the gear-formed concave-convex portion 13 and a click elastic protrusion 45 provided in the click elastic portion 44, enabling to provide a click feeling to free rotation of the inner case 2.

What is claimed is:

1. A wristwatch case comprising:
an outer case; and
an inner case;
wherein the inner case has a structure movable generally vertical with respect to a plane.

2. A wristwatch case according to claim 1, further comprising:
a rotation-regulating ring having a rotation mechanism on a circumference different in rotation function of the inner case at a plurality of stop points in vertical movable range;
wherein the rotation-regulating ring is arranged between the outer case and the inner case.

3. A wristwatch case according to claim 1:
an inner case having a structure movable generally vertical with respect to a plane; and
a positioning elastic member to stop the inner case in each of a plurality of positions.

4. A wristwatch case according to claim 1;
wherein the rotation-regulating ring is arbitrary divided the circumference of the rotation regulating ring and alternately arranged a plurality of rotation mechanisms different in the inner case.

5. A wristwatch case according to claim 4;
wherein the rotation-regulating ring is planarly alternately arranged a plurality of rotation mechanisms different in the inner case.

6. A wristwatch case according to claim 1, further comprising:
a gear-formed concave-convex portion formed in the outer case; and
a click elastic protrusion to interfere with a gear-formed concave-convex portion, to radially move due to a rotation force on the gear-formed concave-convex portion to cause a click feel and to arrange the rotation-regulating ring;
wherein the click elastic protrusion causes a click feel by intermittently interferering with the gear-formed concave-convex portion.

7. A wristwatch case according to claim 6;
wherein the gear-formed concave-convex portion of the outer case is formed to a planar form of the outer case.
